(19) United States
(12) Patent Application Publication
(10) Pub. No.: US 2018/0288109 A1
(43) Pub. Date: Oct. 4, 2018

(54) CONFERENCE SUPPORT SYSTEM, CONFERENCE SUPPORT METHOD, PROGRAM FOR CONFERENCE SUPPORT APPARATUS, AND PROGRAM FOR TERMINAL

(71) Applicant: HONDA MOTOR CO., LTD., Tokyo (JP)

(72) Inventors: Takashi Kawachi, Wako-shi (JP); Kazuhiro Nakadai, Wako-shi (JP); Tomoyuki Sahata, Tokyo (JP); Junko Kai, Hayami-gun (JP); Meari Sayano, Hayami-gun (JP); Keisuke Maeya, Hayami-gun (JP); Kazuya Maura, Hayami-gun (JP)

(21) Appl. No.: 15/934,351

(22) Filed: Mar. 23, 2018

(30) Foreign Application Priority Data
Mar. 30, 2017 (JP) 2017-069181

(51) Int. Cl. H04L 29/06; G10L 15/183; G10L 15/22; G10L 15/26; G06F 17/27

(52) U.S. Cl. CPC H04L 65/403; G10L 15/183; G06F 17/2765; G10L 15/265; G10L 15/22

(57) ABSTRACT

A conference support system has a terminal used by participants in a conference and a conference support apparatus. The conference support apparatus includes an acquisition unit configured to acquire a speech content, a context authentication unit configured to, when a pronoun is included in text information of the speech content, estimate words corresponding to the pronoun, and a communication unit configured to transmit the text information and the estimated words corresponding to the pronoun to the terminal, in which the terminal includes a display unit configured to display the text information and words corresponding to the pronoun.

### CROSS-REFERENCE TO RELATED APPLICATION

Priority is claimed on Japanese Patent Application No. 2017-069181, filed Mar. 30, 2017, the content of which is incorporated herein by reference.

### BACKGROUND OF THE INVENTION

### Field of the Invention

The present invention relates to a conference support system, a conference support method, a program for a conference support apparatus, and a program for a terminal.

### Description of Related Art

When a plurality of persons participate in a conference, it has been suggested to convert utterance content of each speaker into text and to display the utterance content converted into text on a reproducing device possessed by each user (for example, refer to Japanese Unexamined Patent Application, First Publication No. H8-194492 (hereinafter, referred to as Patent Document 1)). In the technology described in Patent Document 1, an utterance is recorded as a voice memo for each topic and a minutes creator plays the recorded voice memo and converts it into text. Then, in the technology described in Patent Document 1, minutes are created by structuring created text in association with other text and the created minutes are displayed on a reproducing device.

### SUMMARY OF THE INVENTION

In an actual conversation, pronouns such as “that” or “this” may be used. However, in a conventional technology such as the technology described in Patent Document 1, when a voice is converted into text as it is, there has been a problem in that it is not known what “that” or “this” corresponds to.

An aspect of the present invention has been made in view of the above problems, and an object of the present invention is to provide a conference support system, a conference support method, a program for a conference support apparatus, and a program for a terminal which, even when a pronoun is uttered by another speaker, can recognize what the content of the pronoun is.

The present invention adopts the following aspects to achieve the above object.

(1) A conference support system according to one aspect of the present invention is a conference support system which comprises terminals used by participants in a conference and a conference support apparatus, in which the conference support apparatus includes an acquisition unit configured to acquire a speech content, a context authentication unit configured to, when a pronoun is included in text information of the speech content, estimate words corresponding to the pronoun, and a communication unit configured to transmit the text information and the estimated words corresponding to the pronoun to the terminal, and the terminal includes a display unit configured to display the text information and the words corresponding to the pronoun.

(2) In the aspect (1) described above, when a pronoun is included in text information of the speech content, the context authentication unit of the conference support apparatus may change a display of the pronoun in the text information.

(3) In the aspect (1) or (2) described above, the acquisition unit of the conference support apparatus may determine whether the speech content is voice information or text information, and the conference support apparatus may include a voice recognition unit configured to recognize the voice information and converts it into text information.

(4) In any one of the aspects (1) to (3) described above, the context authentication unit of the conference support apparatus may perform scoring on a pronoun and estimate a content of the pronoun on the basis of the score.

(5) In any one of the aspects (1) to (4) described above, the terminal may include a display area that displays a content of a pronoun.

(6) In the aspect (5) described above, the display area may be a balloon display.

(7) In any one of the aspects (1) to (6) described above, the terminal may make a display color of the pronoun different from a display color of other words, and display words corresponding to the pronoun transmitted by the conference support apparatus when a pronoun portion is selected, and a communication unit of the conference support apparatus may transmit words corresponding to the pronoun to the terminal when the pronoun portion is selected by the terminal.

(8) A conference support method according to another aspect of the present invention is a conference support method in a conference support system which has terminals used by participants in a conference and a conference support apparatus and includes an acquisition procedure for acquiring, by an acquisition unit of the conference support apparatus, a speech content, a context authentication procedure for determining, by a context authentication unit of the conference support apparatus, whether a pronoun is included in text information of the speech content, and for estimating words corresponding to the pronoun when the pronoun is included, a communication procedure for transmitting, by a communication unit of the conference support apparatus, the text information and the estimated words corresponding to the pronoun to the terminal, and a display procedure that displays, by a display unit of the terminal, the text information and the words corresponding to the pronoun transmitted by the conference support apparatus.

(9) A program for a conference support apparatus according to still another aspect of the present invention causes a computer of the conference support apparatus in a conference support system that has terminals used by participants in a conference and a conference support apparatus to execute steps which include a step of acquiring a speech content, a step of determining whether a pronoun is included in text information of the speech content, a step of estimating words corresponding to the pronoun when the pronoun is included, a step of transmitting the text information to the terminal, and a step of transmitting, when a pronoun portion is selected by the terminal, the words corresponding to the pronoun to the terminal.

(10) A program for a terminal according to still another aspect of the present invention causes a computer of the terminal in a conference support system that has terminals used by participants in a conference and a conference support apparatus to execute steps which includes a step of displaying text information of utterance content of the participants in a conference transmitted by the conference support apparatus by making a display color of a pronoun different from a display color of other words, a step of transmitting, when a pronoun portion has been selected, information indicating the selection to the conference support apparatus, and a step of displaying words corresponding to the pronoun transmitted by the conference support apparatus as a response to the information indicating the selection.

According to the aspects (1), (8), (9), and (10) described above, even when pronouns such as “this” and “that” are spoken, participants in a conference can recognize what the contents of the pronouns are, and thus it becomes easy to participate in a conference. In addition, according to the aspects (1), (8), (9), and (10), since even participants who are hard of hearing or unable to utter can recognize what the content of the pronouns are, it becomes easy to participate in a conference.

According to the aspect (2) described above, since a display of a pronoun is displayed to be different from a display of other comments, it becomes easy to understand that the pronoun is included in an utterance.

According to the aspect (3) described above, no matter whether speech content of participants in a conference is an utterance or text, when a pronoun such as “this” or “that” is spoken in the speech, the participants in a conference can recognize what the content of the pronoun, and thus it becomes easy to participate in the conference.

According to the aspect (4) described above, since words corresponding to a pronoun is estimated using a score, it is possible to improve specific accuracy of a pronoun.

According to the aspect (5) described above, since a display area that displays the content of a pronoun is provided, it becomes easy for participants to understand the content of a pronoun.

According to the aspect (6) described above, it becomes easy for participants to understand the content of a pronoun due to a balloon display.

According to the aspect (7) described above, since a color of a pronoun portion is made different from a color of other comments, and the content of the pronoun is displayed if the pronoun portion is touched, it becomes easy for participants to understand the content of a pronoun.

### BRIEF DESCRIPTION OF THE DRAWINGS

FIG. 1 is a block diagram showing a configuration example of a conference system according to a first embodiment.

FIG. 2 is a diagram showing a conference example according to the first embodiment.

FIG. 3 is a diagram showing examples of a disassembly analysis, a dependency analysis, a morphological analysis, and pronoun estimation according to the first embodiment.

FIG. 4 is a diagram showing an example of images displayed on a display unit of a terminal according to the first embodiment.

FIG. 5 is a sequence diagram showing a processing procedure example of a conference support system according to the first embodiment.

FIG. 6 is a flowchart showing a processing procedure example of a conference support apparatus according to the present embodiment.

### DETAILED DESCRIPTION OF THE INVENTION

Hereinafter, embodiments of the present invention will be described with reference to drawings.

First, a situation example in which a conference support system of the present embodiment is used will be described.

The conference support system of the present embodiment is used in conference participated in by two or more participants. Among participants, there may be a person who is unable to utter participating in a conference. Each of participants who are able to utter wears a microphone. In addition, participants have terminals (smart phones, tablet terminals, personal computers, and the like). The conference support system performs voice recognition on voice signals uttered by participants, converts a result into text, and displays the text on a terminal of each participant.

In addition, when there is a pronoun in the text, the conference support system estimates a word that corresponds to the pronoun by analyzing an utterance before this utterance. A terminal displays the words corresponding to the pronoun in association with the pronoun in accordance with an operation of a user.

### First Embodiment

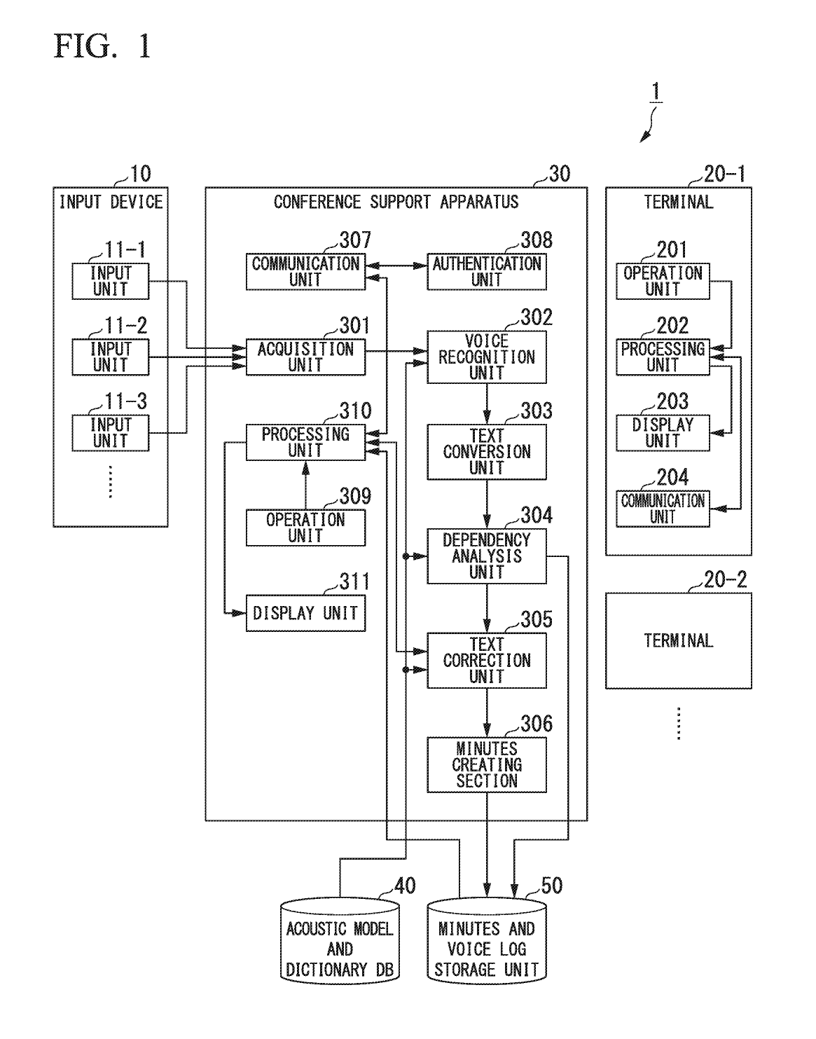

FIG. 1 is a block diagram showing a configuration example of a conference support system 1 according to the present embodiment.

First, a configuration of the conference support system 1 will be described.

As shown in FIG. 1, the conference support system 1 includes an input device 10, a terminal 20, a conference support apparatus 30, an acoustic model and dictionary DB 40, and a minutes and voice log storage unit 50. In addition, the terminal 20 includes a terminal 20-1, a terminal 20-2, . . . , and so forth. When one of the terminal 20-1 and the terminal 20-2 is not specified, it is called the terminal 20.

The input device 10 includes an input unit 11-1, an input unit 11-2, an input unit 11-3, . . . , and so forth. When one of the input unit 11-1, the input unit 11-2, the input unit 11-3, . . . , and so forth is not specified, it is called an input unit 11.

The terminal 20 includes an operation unit 201, a processing unit 202, a display unit 203, and a communication unit 204.

The conference support apparatus 30 includes am acquisition unit 301, a voice recognition unit 302, a text conversion unit 303 (voice recognition unit), a dependency analysis unit 304, a text correction unit 305 (context authentication unit), a minutes creating section 306, a communication unit 307, an authentication unit 308, an operation unit 309, a processing unit 310, and a display unit 311.

The input device 10 and the conference support apparatus 30 are connected in a wired or wireless manner. The terminal 20 and the conference support apparatus 30 are connected in a wired or wireless manner.

First, the input device 10 will be described.

The input device 10 outputs voice signals uttered by a user to the conference support apparatus 30. The input device 10 may also be a microphone array. In this case, the input device 10 has P microphones disposed at different positions. Then, the input device 10 generates acoustic signals of P channels (P is an integer of two or more) from collected sounds, and outputs the generated acoustic signals of P channels to the conference support apparatus 30.

The input unit 11 is a microphone. The input unit 11 collects voice signals of a user, converts the collected voice signals from analog signals into digital signals, and outputs the voice signals which are converted into digital signals to the conference support apparatus 30. The input unit 11 may output voice signals which are analog signals to the conference support apparatus 30. The input unit 11 may output voice signals to the conference support apparatus 30 via wired cords or cables, and may also wirelessly transmit voice signals to the conference support apparatus 30.

Next, the terminal 20 will be described.

The terminal 20 is, for example, a smart-phone, a tablet terminal, a personal computer, or the like. The terminal 20 may include a voice output unit, a motion sensor, a global positioning system (GPS), and the like.

The operation unit 201 detects an operation of a user and outputs a result of the detection to the processing unit 202. The operation unit 201 is, for example, a touch panel type sensor provided on the display unit 203 or a keyboard.

The processing unit 202 generates transmission information in accordance with an operation result output by the operation unit 201, and outputs the generated transmission information to the communication unit 204. The transmission information is one of a request for participation indicating a desire to participate in the conference, a request for a leave indicating a desire to leave a conference, instruction information indicating that pronouns included in text uttered by other participants have been selected, instruction information requesting transmission of past minutes, and the like. The transmission information includes identification information of the terminal 20.

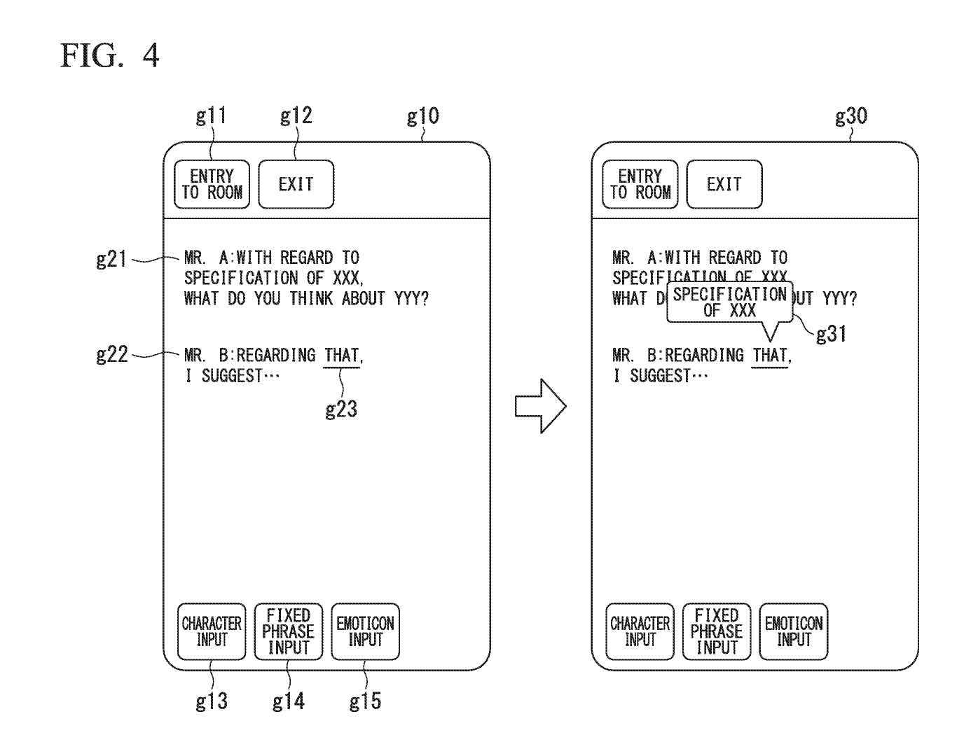

The processing unit 202 acquires text information output by the communication unit 204, converts acquired text information into image data, and outputs converted image data to the display unit 203. Images displayed on the display unit 203 will be described with reference to FIG. 4.

The display unit 203 displays image data output by the processing unit 202. The display unit 203 is, for example, a liquid crystal display device, an organic electroluminescence (EL) display device, an electronic ink display device, or the like.

The communication unit 204 receives text information or information on minutes from the conference support apparatus 30, and outputs received reception information to the processing unit 202. The communication unit 204 transmits instruction information output by the processing unit 202 to the conference support apparatus 30.

Next, the acoustic model and dictionary DB 40 will be described.

For example, an acoustic model, a language model, a word dictionary, and the like are stored in the acoustic model and dictionary DB 40. The acoustic model is a model based on a feature amount of a sound, and a language model is a model of information on words and an arrangement of the words. Moreover, a word dictionary is a dictionary with a number of vocabularies, for example, a large-vocabulary word dictionary. The conference support apparatus 30 may store and update a word or the like, which is not stored in the voice recognition dictionary 13, in the acoustic model and dictionary DB 40. In addition, flags indicating technical terms are associated in the language model stored in the acoustic model and dictionary DB 40. The technical terms are, for example, standard names, method names, technical terms, and the like. Moreover, in the acoustic model and dictionary DB 40, description of a technical term is stored in a dictionary.

Next, the minutes and voice log storage unit 50 will be described.

The minutes and voice log storage unit 50 stores minutes (including voice signals). The minutes and voice log storage unit 50 stores words corresponding to a pronoun. Words corresponding to a pronoun will be described below.

Next, the conference support apparatus 30 will be described.

The conference support apparatus 30 is, for example, one of a personal computer, a server, a smart phone, a tablet terminal, and the like. The conference support apparatus 30 further includes a sound source localization unit, a sound source separation unit, and a sound source identification unit when the input device 10 is a microphone array.

The conference support apparatus 30 performs voice recognition on voice signals uttered by a participant, for example, for each predetermined period of time, and converts recognized voice signals into text. Then, the conference support apparatus 30 transmits text information of utterance content converted into text to each terminal 20 of participants. When a participant operates the terminal 20 to select a pronoun included in an utterance, the conference support apparatus 30 transmits corrected text information including words corresponding to the selected pronoun to at least the terminal 20 with which the pronoun is selected.

The conference support apparatus 30 stores a corresponding relationship between the terminal 20 and the input unit 11.

The acquisition unit 301 acquires voice signals output from the input unit 11, and outputs the acquired voice signals to the voice recognition unit 302. If the acquired voice signals are analog signals, the acquisition unit 301 converts the analog signals into digital signals, and outputs the voice signals which are converted into digital signals to the voice recognition unit 302.

When there are a plurality of input units 11, the voice recognition unit 302 performs voice recognition on each speaker using the input unit 11.

The voice recognition unit 302 acquires voice signals output from the acquisition unit 301. The voice recognition unit 302 detects voice signals in an utterance section from the voice signals output by the acquisition unit 301. In the detection of an utterance section, for example, voice signals of a predetermined threshold value or more are detected as an utterance section. The voice recognition unit 302 may perform the detection of an utterance section using other known techniques. The voice recognition unit 302 refers to the acoustic model and dictionary DB 40 for the voice signals in a detected utterance section, and performs voice recognition using a known technique. The voice recognition unit 302 performs voice recognition using, for example, a technique disclosed in Japanese Unexamined Patent Application First Publication No. 2015-64554. The voice recognition unit 302 outputs a result of the recognition and recognized voice signals to the text conversion unit 303. The voice recognition unit 302 outputs a result of the recognition and voice signals in correspondence with, for example, each sentence, each utterance section, or each speaker.

The text conversion unit 303 converts a result of recognition output by the voice recognition unit 302 into text. The text conversion unit 303 outputs converted text information and voice signals to the dependency analysis unit 304. The text conversion unit 303 may delete interjections such as “ah”, “uh”, “wow”, and “oh” and perform conversion into text.

The dependency analysis unit 304 performs a morphological analysis and a dependency analysis on the text information output by the text conversion unit 303. The dependency analysis unit 304 extracts pronouns (personal pronouns, demonstrative pronouns) on the basis of a result of the analysis. For example, Support Vector Machines (SVM) is used in a Shift-reduction method, a spanning tree method, or a step-by-step application method of chunk identification for the dependency analysis. The dependency analysis unit 304 estimates words corresponding to a pronoun on the basis of a result of the analysis. In the estimation of words corresponding to a pronoun, a score is added to an utterance before an utterance including a pronoun using, for example, the technique of Reference Literature 1 and the like, and estimation of words corresponding to the pronoun is performed on the basis of the score. For example, a total evaluation value described in Reference Literature 1 may be used for the score. An estimated word is, for example, a word. The dependency analysis unit 304 stores the estimated word in the minutes and voice log storage unit 50.

The dependency analysis unit 304 outputs text information which is a result of the dependency analysis, and voice signals to the text correction unit 305. The text information which is a result of the dependency analysis will be described below. In addition, when a pronoun is extracted, the dependency analysis unit 304 includes information indicating the pronoun and words corresponding to the pronoun in text information and outputs the text information to the text correction unit 305.

Furthermore, the dependency analysis unit 304 refers to the acoustic model and dictionary DB 40 after the morphological analysis and the dependency analysis are performed, and extract technical terms when technical terms are included. In addition, the dependency analysis unit 304 reads description corresponding to the technical terms from the acoustic model and dictionary DB 40. The dependency analysis unit 304 outputs information indicating the technical terms and text information on the description of the technical terms to the text correction unit 305. The dependency analysis unit 304 determines whether there are technical terms on the basis of flags associated with words stored in the acoustic model and dictionary DB 40.

Reference Literature 1: “Deep-level demonstrative pronoun anaphora system Ansys/D based on vocabulary”, Yamazaki Kenji, Muramatsu Takahiko, Harada Minoru, Aoyama Gakuin University, Department of Engineering Science, Faculty of Science and Technology, Natural Language Processing Study Group 153-5, Information Processing Society, 20 Jan. 2003, p 33-p 40

The text correction unit 305 corrects text information by performing correction of a font color of a pronoun, correction of a font size, correction of a font type, and correction by adding an underline and the like to a font when information indicating the pronoun is included in the text information output by the dependency analysis unit 304. The text correction unit 305 outputs the text information output by the dependency analysis unit 304 or corrected text information to the processing unit 310. The text correction unit 305 corrects text information such that words corresponding to a pronoun included in the text information output by the dependency analysis unit 304 is displayed in association with the pronoun when the processing unit 310 has output a correction instruction. The text correction unit 305 outputs the text information output by the dependency analysis unit 304 and voice signals to the minutes creating section 306.

Furthermore, the text correction unit 305 corrects a display of a technical term and outputs corrected text information to the processing unit 310 when the dependency analysis unit 304 has output information indicating the technical term and text information on a description of the technical term. The text correction unit 305 corrects text information such that words corresponding to the text information on the description of the technical term output by the dependency analysis unit 304 is displayed in association with the technical term when the processing unit 310 has output a correction instruction.

The minutes creating section 306 creates minutes for each speaker on the basis of text information and voice signals output by the text correction unit 305. The minutes creating section 306 stores voice signals corresponding to created minutes in the minutes and voice log storage unit 50. The minutes creating section 306 may create minutes by deleting interjections such as “ah”, “uh”, “wow”, and “oh”.

The communication unit 307 transmits or receives information to or from the terminal 20. Information received from the terminal 20 includes a request for participation, voice signals, instruction information (including instruction information indicating that a pronoun included in text uttered by other participants has been selected), instruction information which requests transmission of past minutes, and the like. The communication unit 307 extracts, for example, identification information for identifying a terminal 20 from the request for participation received from the terminal 20, and outputs the extracted identification information to the authentication unit 308. The identification information is, for example, a serial number of the terminal 20, a Media Access Control (MAC) address, an Internet Protocol (IP) address, and the like. The communication unit 307 communicates with a terminal 20 which has requested participation in a conference when the authentication unit 308 has output an instruction for allowing communication participation. The communication unit 307 does not communicate with the terminal 20 which has requested participation in a conference when the authentication unit 308 has output an instruction for not allowing communication participation. The communication unit 307 extracts instruction information from the received information and outputs the extracted instruction information to the processing unit 310. The communication unit 307 transmits the text information or corrected text information output by the processing unit 310 to the terminal 20 which has requested participation. The communication unit 307 transmits information on minutes output by the processing unit 310 to the terminal 20 which has requested participation or a terminal 20 which has transmitted instruction information requesting transmission of past minutes.

The authentication unit 308 receives identification information output by the communication unit 307, and determines whether to allow communication. The conference support apparatus 30, for example, receives registration of terminals 20 used by participants in a conference, and registers it in the authentication unit 308. The authentication unit 308 outputs an instruction for allowing communication participation or an instruction for not allowing communication participation to the communication unit 307 in accordance with a result of the determination.

The operation unit 309 is, for example, a keyboard, a mouse, a touch panel sensor provided on the display unit 311, and the like. The operation unit 309 detects an operation result of a user, and outputs the detected operation result to the processing unit 310.

The processing unit 310 generates a correction instruction that displays words corresponding to a pronoun on the basis of a result of the analysis performed by the dependency analysis unit 304 and outputs the generated correction instruction to the text correction unit 305 in accordance with instruction information output by the communication unit 307.

Moreover, the processing unit 310 generates a correction instruction that displays words corresponding to a technical term on the basis of a result of the analysis performed by the dependency analysis unit 304 and outputs the generated correction instruction to the text correction unit 305 in accordance with the instruction information output by the communication unit 307.

The processing unit 310 outputs the text information or the corrected text information output by the text correction unit 305 to the communication unit 307. The processing unit 310 extracts identification information from instruction information, and transmits the corrected text information to a terminal 20 corresponding to the extracted identification information via the communication unit 307. Specifically, the processing unit 310 transmits corrected text information including words corresponding to a pronoun to a terminal 20 which has selected the pronoun. The processing unit 310 may also transmit corrected text information including words corresponding to a pronoun to other terminals 20.

The processing unit 310 reads minutes from the minutes and voice log storage unit 50 in accordance with the instruction information requesting transmission of past minutes, and outputs information on read minutes to the communication unit 307. The information on minutes may include information indicating a speaker, information indicating a result of a dependency analysis, information indicating a result of correction by the text correction unit 305, and the like.

The display unit 311 displays image data output by the processing unit 310. The display unit 311 is, for example, a liquid crystal display device, an organic EL display device, an electronic ink display device, or the like.

When the input device 10 is a microphone array, the conference support apparatus 30 further includes a sound source localization unit, a sound source separation unit, and a sound source identification unit. In this case, a sound source localization unit of the conference support apparatus 30 performs sound source localization on voice signals acquired by the acquisition unit 301 using a transfer function generated in advance. Then, the conference support apparatus 30 performs speaker identification using a result of the localization performed by the sound source localization unit. The conference support apparatus 30 performs sound source separation on the voice signals acquired by the acquisition unit 301 using a result of the localization performed by the sound source localization unit. Then, the voice recognition unit 302 of the conference support apparatus 30 performs detection of an utterance section and voice recognition on separated voice signals (for example, refer to Japanese Unexamined Patent Application, First Publication No. 2017-9657). In addition, the conference support apparatus 30 may perform de-reverberation processing.

Here, a conference example in the following description will be described.

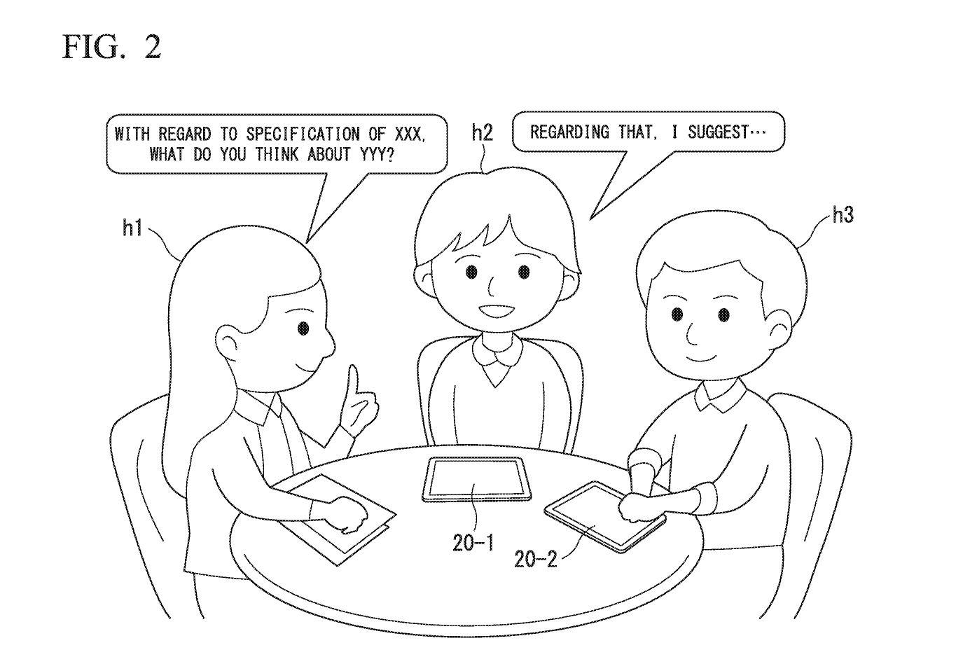

FIG. 2 is a diagram showing a conference example according to the present embodiment. In the example shown in FIG. 2, there are three participants in a conference (a first participant h1, a second participant h2, and a third participant h3). Here, it is assumed that the second participant h2 is hard of hearing but is able to utter. In addition, it is assumed that the third participant h3 is hard of hearing and is unable to utter. The first participant h1 is equipped with the input unit 11-1 (microphone). The second participant h2 is equipped with the input unit 11-2.

The third participant h3 is not equipped with the input unit 11. In addition, it is assumed that the second participant h2 uses the terminal 20-1 and the third participant h3 uses the terminal 20-2.

Each of the second participant h2 and the third participant h3 is able to understand utterance content of other participants by looking at the utterance content which is converted into text displayed on the terminal 20. In addition, when a pronoun is included in utterance of participants, each of the second participant h2 and the third participant h3 can understand the utterance content of other participants by words corresponding to the pronoun being displayed on the terminals.

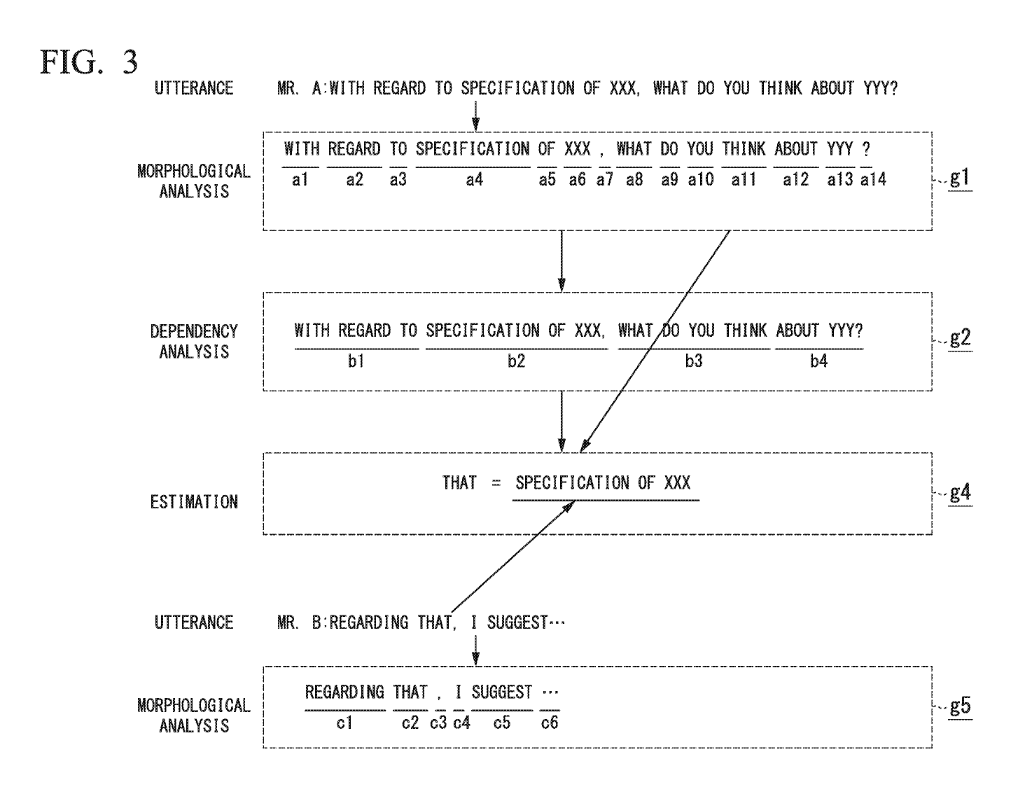

Next, an analysis example of the utterance content will be described. FIG. 3 is a diagram showing an example of a disassembly analysis, a dependency analysis, a morphological analysis, and pronoun estimation according to the present embodiment. In the example of FIG. 3, there is an example in which Mr. B has uttered “Regarding that, I suggest . . . ” after Mr. A says “With regard to a specification of XXX, what do you think about YYY?”. Mr. A is the first participant h1 and Mr. B is the second participant h2 in FIG. 3.

An area indicated by a reference numeral g1 is a result of performing a morphological analysis on an utterance of Mr. A. The result of performing the morphological analysis is that, “With regard to a specification of XXX, what do you think about YYY?” has 14 morphemes.

An area indicated by a reference numeral g2 is a result of performing the dependency analysis on an utterance of Mr. B. As a result of performing the dependency analysis, “With regard to a specification of XXX, what do you think about YYY?” has 4 morphemes.

An area indicated by a reference numeral g5 is a result of performing the morphological analysis on the utterance of Mr. A. As a result of performing the morphological analysis, “Regarding that, I suggest . . . ” has 6 morphemes.

An area indicated by a reference numeral g4 is a result of estimation of a vocabulary corresponding to the pronoun of the morpheme c2 “that” included in the utterance of Mr. B. As a result, the dependency analysis unit 304 estimates “a specification of XXX” of the utterance of Mr. A is the pronoun “that”.

Next, an example of an image displayed on the display unit 203 of the terminal 20 will be described using FIG. 4 with reference to FIGS. 2 and 3.

FIG. 4 is a diagram showing an example of images displayed on a display unit 203 of the terminal 20 according to the present embodiment.

First, an image g10 will be described.

The image g10 is an image example displayed on the display unit 203 of the terminal 20 when Mr. B has uttered after Mr. A utters. The image g10 includes an image g11 of an entry button, an image g12 of an exit button, an image g13 of a character input button, an image g14 of a fixed phrase input button, an image 15 of an emoticon input button, an image g21 of text of the utterance of Mr. A, and an image g22 of text of the utterance of Mr. B.

The image g11 of an entry button is an image of a button selected when a participant participates in a conference. The image g12 of an exit button is an image of a button selected when a participant leaves a conference or the conference ends.

The image g13 of a character input button is an image of a button selected when a participant does not utter using a voice, but inputs characters by operating the operation unit 201 of the terminal 20.

The image g14 of a fixed phrase input button is an image of a button selected when a participant does not utter using a voice but inputs a fixed form by operating the operation unit 201 of the terminal 20. If this button is selected, a plurality of fixed phrases are displayed and a participant selects one from the plurality of displayed fixed phrases. The fixed phrases are, for example, “Good morning”, “Hello”, “It is cold today”, “It is hot today”, “Can I go to a bathroom?”, “Would you like to take a break here?”, and the like.

The image g15 of an emoticon input button is an image of a button selected when a participant does not utter using a voice but inputs an emoticon by operating the operation unit 201 of the terminal 20.

The image g21 of text of the utterance of Mr. A is text information after voice signals uttered by Mr. A are processed by the text conversion unit 303 and the dependency analysis unit 304. In the example shown in FIG. 4, the utterance of Mr. A does not include a pronoun.

The image g22 of text of the utterance of Mr. B is text information after voice signals uttered by Mr. B are processed by the text conversion unit 303 and the dependency analysis unit 304. In the example shown in FIG. 4, the utterance of Mr. B includes a pronoun. For this reason, the text correction unit 305 corrects a display of a pronoun “this” (at least one of correction of a font color, correction of a font size, and addition of an underline to a font). The example shown in FIG. 4, as indicated by the image g23, is an example in which correction of a font color and addition of an underline are performed on the pronoun “this”.

Next, an image g30 will be described.

The image g30 is an example of an image displayed on the display unit 203 of the terminal 20 when an image g23 of the image g10 has been selected.

The processing unit 202 of the terminal 20 transmits instruction information indicating that the selected pronoun “this” has been selected when the image g23 has been selected by operating the operation unit 201 to the conference support apparatus 30. The text correction unit 305 of the conference support apparatus 30 performs text correction processing of changing text information of a word “specification of ∘∘” corresponding to the pronoun “this” such that it is displayed in association with the pronoun “this” in accordance with received instruction information. The processing unit 310 of the conference support apparatus 30 transmits corrected text information to the terminal 20. The processing unit 202 of the terminal 20 displays the corrected text information received from the conference support apparatus 30 as the image g30. An image g31 is words corresponding to the pronoun “this”, and is displayed in association with the pronoun “this” as shown in the image g30. The example shown in FIG. 4 is an example displayed using a balloon. A display position (display area) of the words corresponding to a pronoun or the description of a technical term may be on top of a pronoun, to the upper right of a pronoun, to the upper left of a pronoun, above of a pronoun, under a pronoun, to the lower left of a pronoun, to the lower right of a pronoun, or the like, and may also be a separate frame in a screen. As described above, a display area that displays the content of a pronoun or the description of a technical term is provided in the present embodiment.

The processing unit 202 of the terminal 20 may display the image g31 of words corresponding to a pronoun on a different layer from the images g21 and g22 of text information indicating utterance content.

Moreover, in the example shown in FIG. 4, examples of buttons displayed on the display unit 203 have been described, but these buttons may also be physical buttons (operation button 201).

Next, a processing procedure example of the conference support system 1 will be described.

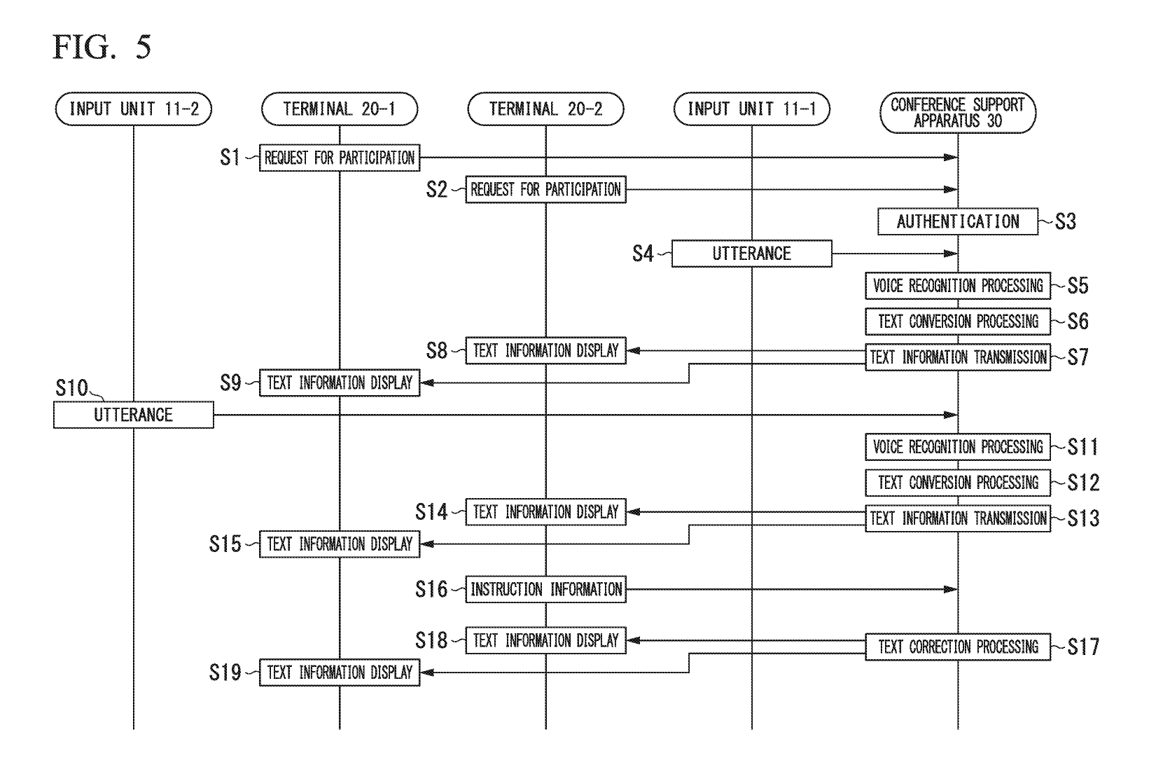

FIG. 5 is a sequence diagram showing a processing procedure example of the conference support system 1 according to the present embodiment.

The example shown in FIG. 5 is, like the example described using FIGS. 2 to 4, an example in which three participants (users) participate in a conference. A participant A is a participant using the conference support apparatus 30 and is equipped with the input unit 11-1. A participant B is a participant using the terminal 20-1 and is equipped with the input unit 11-2. A participant C is a participant using the terminal 20-2 and is not equipped with the input unit 11.

(Step S1) The participant B selects the image g11 (FIG. 4) of an entry button by operating the operation unit 201 of the terminal 20-1 and participates in the conference. The processing unit 202 of the terminal 20-1 transmits a request for participation to the conference support apparatus 30 in accordance with a result of the selection of the image g11 of an entry button by the operation unit 201.

(Step S2) The participant C selects the image g11 of an entry button by operating the operation unit 201 of the terminal 20-2 and participates in the conference. The processing unit 202 of the terminal 20-2 transmits a request for participation to the conference support apparatus 30 in accordance with a result of the selection of the image g11 of an entry button by the operation unit 201.

(Step S3) The communication unit 307 of the conference support apparatus 30 receives requests for participation transmitted by each of the terminal 20-1 and the terminal 20-2. Subsequently, the communication unit 307 extracts, for example, identification information for identifying the terminal 20 from the requests for participation received from the terminal 20. Subsequently, the authentication unit 308 of the conference support apparatus 30 receives the identification information output by the communication unit 307 and performs authentication regarding whether to allow communication. The example shown in FIG. 5 is an example in which the terminal 20-1 and the terminal 20-2 are allowed to participate.

(Step S4) The participant A makes an utterance. The input unit 11-1 outputs voice signals to the conference support apparatus 30.

(Step S5) The voice recognition unit 302 of the conference support apparatus 30 performs voice recognition processing on the voice signals output by the input unit 11-1 (voice recognition processing).

(Step S6) The text conversion unit 303 of the conference support apparatus 30 converts voice signals into text (text conversion processing). Subsequently, the dependency analysis unit 304 of the conference support apparatus 30 performs a dependency analysis on text information.

(Step S7) The processing unit 310 of the conference support apparatus 30 transmits text information to each of the terminal 20-1 and the terminal 20-2 via the communication unit 307.

(Step S8) The processing unit 202 of the terminal 20-2 receives text information transmitted by the conference support apparatus 30 via the communication unit 204, and displays the received text information on the display unit 203 of the terminal 20-2.

(Step S9) The processing unit 202 of the terminal 20-1 receives text information transmitted by the conference support apparatus 30 via the communication unit 204, and displays the received text information on the display unit 203 of the terminal 20-1.

(Step S10) The participant B makes an utterance. The input unit 11-2 transmits voice signals to the conference support apparatus 30.

(Step S11) The voice recognition unit 302 of the conference support apparatus 30 performs voice recognition processing on the voice signals transmitted by the input unit 11-2.

(Step S12) The text conversion unit 303 of the conference support apparatus 30 converts voice signals into text. Subsequently, the dependency analysis unit 304 of the conference support apparatus 30 performs a dependency analysis on text information.

(Step S13) The processing unit 310 of the conference support apparatus 30 transmits text information to each of the terminal 20-1 and the terminal 20-2 via the communication unit 307.

(Step S14) The processing unit 202 of the terminal 20-2 performs the same processing as in step S8. After this processing, the image g10 (FIG. 4) is displayed on the display unit 203 of the terminal 20-2.

(Step S15) The processing unit 202 of the terminal 20-1 performs the same processing as in step S9. After this processing, the image g10 (FIG. 4) is displayed on the display unit 203 of the terminal 20-1.

(Step S16) The participant C operates the operation unit 201 of the terminal 20-2 and performs an instruction.

Specifically, in FIG. 4, the participant C selects the image g23 of a pronoun “this” in “this is . . . ” uttered by the participant B. The processing unit 202 of the terminal 20-2 detects this operation. Subsequently, the processing unit 202 of the terminal 20-1 transmits instruction information to the conference support apparatus 30 in accordance with an operation of the participant C. Here, the instruction information includes information indicating that a pronoun “this” included in an utterance of the participant B is selected and identification information of the terminal 20-2.

(Step S17) The text correction unit 305 of the conference support apparatus 30 corrects text information in accordance with the instruction information transmitted by the terminal 20-1. Specifically, in FIG. 4, the text correction unit 305 corrects text information such that words “specification of ∘∘” corresponding to the pronoun “this” included in the utterance of the participant B is displayed in association with the pronoun “this”. Subsequently, the processing unit 310 of the conference support apparatus 30 transmits the corrected text information to each of the terminal 20-1 and the terminal 20-2 via the communication unit 307. The processing unit 310 may transmit the corrected text information only to the terminal 20-2 corresponding to identification information extracted from the instruction information.

(Step S18) The processing unit 202 of the terminal 20-2 receives the corrected text information transmitted by the conference support apparatus 30 via the communication unit 204, and displays the received corrected text information on the display unit 203 of the terminal 20-2. Specifically, the processing unit 202 displays the word “specification of ∘∘” corresponding to the pronoun “this” included in the utterance of the participant B in association with the pronoun “this” in FIG. 4.

(Step S19) The processing unit 202 of the terminal 20-1 receives the corrected text information transmitted by the conference support apparatus 30 via the communication unit 204, and displays the received corrected text information on the display unit 203 of the terminal 20-1. Specifically, the processing unit 202 displays the words “specification of ∘∘” corresponding to the pronoun “this” included in the utterance of the participant B in association with the pronoun “this” in FIG. 4.

In the example shown in FIG. 5, an example in which the participant A uses the conference support apparatus 30 has been described, but the present invention is not limited thereto. The conference support apparatus 30 may be used by an administrator of the conference support system 1, and each of participants of a conference may use the terminal 20.

Next, a processing procedure example of the conference support apparatus 30 will be described.

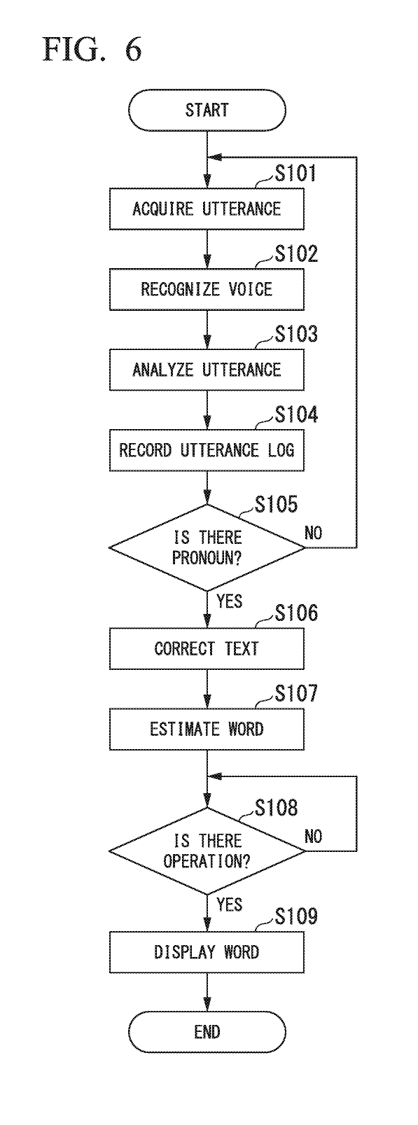

FIG. 6 is a flowchart showing a processing procedure example of the conference support apparatus 30 according to the present embodiment.

(Step S101) The acquisition unit 301 acquires an uttered voice signal.

(Step S102) The voice recognition unit 302 performs voice recognition processing on an acquired voice signal.

(Step S103) The dependency analysis unit 304 performs the morphological analysis and the dependency analysis on text information which is voice-recognized and converted into text to perform an utterance analysis (context authentication).

(Step S104) The minutes creating section 306 creates minutes for each speaker on the basis of the text information and the voice signals output by the text correction unit 305. Subsequently, the minutes creating section 306 stores voice signals corresponding to created minutes in the minutes and voice log storage unit 50.

(Step S105) The dependency analysis unit 304 determines whether a pronoun is included in uttered content on the basis of a result of the morphological analysis and the dependency analysis (context authentication). The dependency analysis unit 304 proceeds to processing of step S106 if it is determined that a pronoun is included (YES in step S105), and returns to the processing of step S101 if it is determined that a pronoun is not included (NO in step S105).

(Step S106) When a pronoun is included in an utterance as a result of the analysis performed by the dependency analysis unit 304, the text correction unit 305 corrects (changes) a display of the pronoun included in text information. The correction (change) of the display of the pronoun is, for example, like the example shown in FIG. 4, correction of a font color of the pronoun, correction of a font size, correction of a font type, and correction by adding an underline to a font, or the like.

(Step S107) The dependency analysis unit 304 performs scoring on an utterance before this utterance including the pronoun, and estimation of words corresponding to the pronoun is performed on the basis of the score (context authentication).

(Step S108) The processing unit 310 determines whether the communication unit 307 has received instruction information from the terminal 20, that is, whether the operation unit 201 of the terminal 20 has been operated. A user operates the operation unit 201 of the terminal 20 and selects the image g23 (FIG. 4) of the pronoun.

The processing unit 310 proceeds to processing of step S109 when it is determined that the operation unit 201 of the terminal 20 has been operated (YES in step S108), and repeats the processing of step S108 when it is determined that the operation unit 201 of the terminal 20 has not been operated (NO in step S108).

(Step S109) The processing unit 310 transmits text information corrected to display the words corresponding to the pronoun to the terminal 20 in accordance with instruction information received from the terminal 20, and thereby displaying the word on the display unit 203 of the terminal 20. Here, the corrected text information is information including at least text information of the words corresponding to the pronoun and a display position. The processing unit 310 may transmit the corrected text information to a terminal 20 which has transmitted instruction information when there are a plurality of terminals 20, or may transmit the information to all of the terminals 20. The processing unit 310 may transmit the corrected text information only to a terminal 20 corresponding to identification information extracted from instruction information, or may transmit the information to all of the terminals 20.

As described above, in the present embodiment, a word portion corresponding to a pronoun “this” or “that” is recognized in context authentication. Then, for example, a balloon display is provided and the words corresponding to the pronoun “that” or “this” is displayed on the display unit 203 of the terminal 20 in the present embodiment. In addition, when the pronoun “that” or “this” is in text, coloring of the portion is made different from other texts to be displayed (for example, a red character) on the display unit 203 of the terminal 20, and the words corresponding to “that” or “this” is displayed on the display unit 203 of the terminal 20 if the portions are touched in the present embodiment. Furthermore, registered technical terms are recognized and also displayed on the display unit 203 of the terminal 20 in the present embodiment.

As a result, according to the present embodiment, even when a pronoun “this”, “that”, or the like is uttered, since participants in a conference can recognize what the content of the pronoun is, it becomes easy to participate in the conference. As a result, according to the present embodiment, since even participants who are hard of hearing or unable to utter can recognize what the content of the pronoun is, it becomes easy to participate in a conference.

In addition, according to the present embodiment, since words corresponding to a pronoun is estimated using a score, it is possible to improve accuracy when identifying a pronoun.

In addition, according to the present embodiment, since a display area that displays the content of a pronoun is provided, it becomes easy for participants to understand the content of a pronoun.

Moreover, according to the present embodiment, it becomes easy for participants to understand the content of a pronoun due to a balloon display.

Furthermore, according to the present embodiment, since a color of a pronoun portion is made different from a color of other comments, and the content of the pronoun is displayed if the pronoun portion is touched, it becomes easy for participants to understand the content of a pronoun.

In the present embodiment, although examples of a pronoun and technical terms have been described as an example which can be selected from a terminal side by correcting a display of the examples such that they become different, the present invention is not limited thereto. For example, this may be a person's name, a place name (a factory name or an office name), a company name, or the like.

In addition, a search for words corresponding to a pronoun may be performed from speech before a speech including the pronoun, and may also be performed from, for example, minutes of a related immediately preceding or previous conference. In this case, the dependency analysis unit 304 may firstly search for words corresponding to a pronoun from the utterance of a conference being held, and may search for it from previous minutes when a word of a predetermined score is not found.

In this manner, according to the present embodiment, since words corresponding to “this” or “that” in converted text is displayed on the terminal 20, a person with hearing impairment can understand the content of a conference. In addition, according to the present embodiment, even when a technical term is included in an utterance, a commentary of the technical term can be displayed on the terminal 20, and thus a person with hearing impairment can follow a conference.

In the example described above, an example of text conversion into Japanese when an utterance is made in Japanese has been described, but the text conversion unit 303 may perform text translation into a language different from an uttered language using a well-known translation technique. In this case, a language displayed on each terminal 20 may be selected by a user of a terminal 20. For example, Japanese text information may be displayed on the display unit 203 of the terminal 20-1, and English text information may be displayed on the display unit 203 of the terminal 20-2.

### Second Embodiment

In the first embodiment, an example in which signals acquired by the acquisition unit 301 are voice signals has been described, but acquired information may be text information. This case will be described with reference to FIG. 1.

The input unit 11 is a microphone or a keyboard (including a touch panel type keyboard). When the input unit 11 is a microphone, the input unit 11 collects voice signals of participants, converts the collected voice signals from analog signals into digital signals, and outputs the voice signals which are converted into digital signals to the conference support apparatus 30. When the input unit 11 is a keyboard, the input unit 11 detects operations of participants, and outputs text information which is a result of the detection to the conference support apparatus 30. When the input unit 11 is a keyboard, the input unit 11 may be the operation unit 201 of the terminal 20. The input unit 11 may output voice signals or text information to the conference support apparatus 30 via wired cords or cables, or may also transmit them to the conference support apparatus 30 wirelessly. When the input unit 11 is the operation unit 201 of the terminal 20, participants, for example, as shown in FIG. 4, select and operate the image g13 of a character input button, the image g14 of a fixed phrase input button, and the image g15 of an emoticon input button. When the image g13 of a character input button is selected, the processing unit 202 of the terminal 20 displays an image of a software keyboard on the display unit 203.

The acquisition unit 301 determines whether acquired information is voice signals or text information. The acquisition unit 301 outputs acquired text information to the dependency analysis unit 304 via the voice recognition unit 302 and the text conversion unit 303 when it is determined that the acquired information is text information.

In the present embodiment, even when text information is input as described above, the text information is displayed on the display unit 203 of the terminal 20.

In addition, in the present embodiment, the morphological analysis and the dependency analysis, detection of a pronoun, and detection of a technical term are performed on the input text information, and a pronoun or a technical term is corrected and displayed on the display unit 203 of the terminal 20.

Moreover, in the present embodiment, when the operation unit 201 of the terminal 20 is operated and a pronoun or a technical term is selected, words corresponding to the pronoun or a description of technical term corresponding to the technical term is displayed on a display area.

As a result, according to the present embodiment, even if an input is text information, it is possible to achieve the same effect as in the first embodiment.

All or a part of processing performed by the conference support system 1 may be performed by recording a program for realizing all or a part of the functions of the conference support system 1 in the present invention in a computer-readable recording medium, and causing a computer system to read and execute the program recorded in this recording medium. The “computer system” herein includes hardware such as an OS and peripheral devices. In addition, the “computer system” also includes a WWW system having a homepage providing environment (or a display environment). Moreover, the “computer-readable recording medium” refers to a portable medium such as a flexible disc, a magneto-optical disc, a ROM, and a CD-ROM, or a storage device such as a hard disk embedded in a computer system. Furthermore, the “computer-readable recording medium” includes a medium holding a program for a certain period of time like a volatile memory (RAM) in a computer system serving as a server or a client when a program is transmitted via a network such as the Internet or a communication line such as a telephone line.

In addition, the program may be transmitted to another computer system from a computer system in which the program is stored in a storage device and the like via a transmission medium or by a transmission wave in a transmission medium. Here, the “transmission medium” which transmits a program refers to a medium having a function of transmitting information like a network (communication network) such as the Internet or a communication line (communication line) such as a telephone line. In addition, the program may be a program for realizing a part of the functions described above. Furthermore, the program may also be a so-called difference file (a difference program) which can realize the functions described above in combination with a program which is already recorded in a computer system.

What is claimed is:

1. A conference support system which comprises terminals used by participants in a conference and a conference support apparatus,
wherein the conference support apparatus includes:
an acquisition unit configured to acquire a speech content,
a context authentication unit configured to, when a pronoun is included in text information of the speech content, estimate words corresponding to the pronoun, and
a communication unit configured to transmit the text information and the estimated words corresponding to the pronoun to the terminal, and
wherein the terminal includes
a display unit configured to display the text information and the words corresponding to the pronoun.

2. The conference support system according to claim 1,
wherein, when a pronoun is included in text information of the speech content, the context authentication unit of the conference support apparatus changes a display of the pronoun in the text information.

3. The conference support system according to claim 1,
wherein the acquisition unit of the conference support apparatus determines whether the speech content is voice information or text information, and
the conference support apparatus includes a voice recognition unit configured to recognize the voice information and converts it into text information.

4. The conference support system according to claim 1,
wherein the context authentication unit of the conference support apparatus performs scoring on a pronoun and estimates a content of the pronoun on the basis of the score.

5. The conference support system according to claim 1,
wherein the terminal includes a display area that displays a content of a pronoun.

6. The conference support system according to claim 5,
wherein the display area is a balloon display.

7. The conference support system according to claim 1,
wherein the terminal makes a display color of the pronoun different from a display color of other words and displays words corresponding to the pronoun transmitted by the conference support apparatus when a pronoun portion is selected, and
a communication unit of the conference support apparatus transmits words corresponding to the pronoun to the terminal when the pronoun portion is selected by the terminal.

8. A conference support method in a conference support system which has terminals used by participants in a conference and a conference support apparatus, the method comprising:
an acquisition procedure for acquiring, by an acquisition unit of the conference support apparatus, a speech content;
a context authentication procedure for determining, by a context authentication unit of the conference support apparatus, whether a pronoun is included in text information of the speech content, and for estimating words corresponding to the pronoun when the pronoun is included;
a communication procedure for transmitting, by a communication unit of the conference support apparatus, the text information and the estimated words corresponding to the pronoun to the terminal; and
a display procedure that displays, by a display unit of the terminal, the text information and the words corresponding to the pronoun transmitted by the conference support apparatus.

9. A program for a conference support apparatus which causes a computer of the conference support apparatus in a conference support system that has a terminal used by participants in a conference and a conference support apparatus to executes steps, the steps comprising:
a step of acquiring a speech content;
a step of determining whether a pronoun is included in text information of the speech content;
a step of estimating words corresponding to the pronoun when the pronoun is included;
a step of transmitting the text information to the terminal; and
a step of transmitting, when a pronoun portion is selected by the terminal, the words corresponding to the pronoun to the terminal.

10. A program for a terminal which causes a computer of the terminal in a conference support system that has a terminal used by participants in a conference and a conference support apparatus to execute steps, the steps comprising:
a step of displaying text information of utterance content of the participants in a conference transmitted by the conference support apparatus by making a display color of a pronoun different from a display color of other words;
a step of transmitting, when a pronoun portion has been selected, information indicating the selection to the conference support apparatus; and
a step of displaying words corresponding to the pronoun transmitted by the conference support apparatus as a response to the information indicating the selection.
